(19) United States
(12) Patent Application Publication
(10) Pub. No.: US 2023/0406684 A1
(43) Pub. Date: Dec. 21, 2023

(54) CONSTRUCTION TOOL

(71) Applicant: Charles Edwards, Orlando, FL (US)

(72) Inventor: Charles Edwards, Orlando, FL (US)

(21) Appl. No.: 18/142,644

(22) Filed: May 3, 2023

Related U.S. Application Data
(60) Provisional application No. 63/354,000, filed on Jun. 21, 2022.

(51) Int. Cl. B66F 9/18; B66F 9/12

(52) U.S. Cl. CPC B66F 9/18; B66F 9/127

(57) ABSTRACT

An apparatus (100), having: a left support (170), a left #1 shaft (172A) configured to cantilever from the left support when in an extended position, and a left #2 shaft (172B) configured to cantilever from the left support above the left #1 shaft; a right support (180), a right #1 shaft (182A) configured to cantilever from the right support when in an extended position, and a right #2 shaft (182B) configured to cantilever from the right support above the right #1 shaft. The left #1 shaft and the right #1 shaft are selectively extendable and retractable and configured to support a first horizontal load when in the extended position. The left #2 shaft and the right #2 shaft are selectively extendable and retractable and configured to support a second horizontal load over the first horizontal load when in the extended position.

### CROSS-REFERENCE TO RELATED APPLICATIONS

This application claims benefit of Provisional Application No. 63/354,000, filed Jun. 21, 2022, the entire contents of which are hereby incorporated by reference as if fully set forth herein, under 35 U.S.C. § 119(e).

### FIELD OF THE INVENTION

The invention relates to a load carrying and distributing device suitable for use with a load-carrying vehicle.

### BACKGROUND OF THE INVENTION

Various items are typically delivered to elevated delivery positions via load-carrying vehicles (e.g., boom vehicle, forklift etc.) that carry the load on conventional forks disposed at the end of a boom. The industry has developed a variety of task-specific attachments that can be secured to the forks for specific carrying and delivering purposes. However, there remains room in the art for improvement.

### BRIEF DESCRIPTION OF THE DRAWINGS

The invention is explained in the following description in view of the drawings that show:

FIG. 1 is a perspective view of an example embodiment of a load carrying and distributing device.

FIG. 2A is a perspective view of an example embodiment of a left assembly of the load carrying and distributing device of FIG. 1.

FIG. 2B is a side view of an example embodiment of a right assembly of the load carrying and distributing device of FIG. 1.

FIG. 2C is a bottom view of the right assembly of FIG. 2B.

FIG. 3 is a cross section of the left assembly of FIG. 1.

FIG. 4A is a perspective view of an example embodiment of a left support of the left assembly of FIG. 3.

FIG. 4B is a perspective view of an example embodiment of a rear actuator mount of the left assembly of FIG. 3.

FIG. 4C is a perspective view of an example embodiment of a roller mount plate of the left assembly of FIG. 3.

FIG. 4D is a perspective view of an example embodiment of a roller bracket of the left assembly of FIG. 3.

FIG. 5A to FIG. 5C show various steps associated with distributing a load using the load carrying and distributing device.

FIG. 6 is a perspective view of another example embodiment of a load carrying and distributing device.

FIG. 7 is a perspective view of an example embodiment of the left assembly of the load carrying and distributing device of FIG. 6.

FIG. 8 is a side view of an example embodiment of the right assembly of the load carrying and distributing device of FIG. 6.

FIG. 9 is a perspective view of an example embodiment of the right support of the right assembly of FIG. 8.

FIG. 10A to FIG. 10D are inside side, front side, outside side, and perspective views of an example embodiment of a guard of the right guard assembly of FIG. 8.

### DETAILED DESCRIPTION OF THE INVENTION

The Inventor has developed a unique and innovative load carrying and distributing device suited for carrying and delivering a load composed of a stack of discrete pieces (or discrete groups of pieces). The pieces of the load are maintained in a stack during transport and can be delivered, one at a time, to a variety of different destinations without need for a person to handle the individual pieces during the delivery.

The load carrying and distributing device can be utilized to facilitate a variety of carrying and distributing operations. In an example use, the load carrying and distributing device can be used to deliver a stack of purlins to a worksite and then to distribute individual purlins to various installation locations along rafters. Delivering the purlins to the actual location where the purlin will be installed onto the rafters without the need for human handling during the delivery significantly speeds the purlin installation process which, in turn, decreases the time it takes to construct the building.

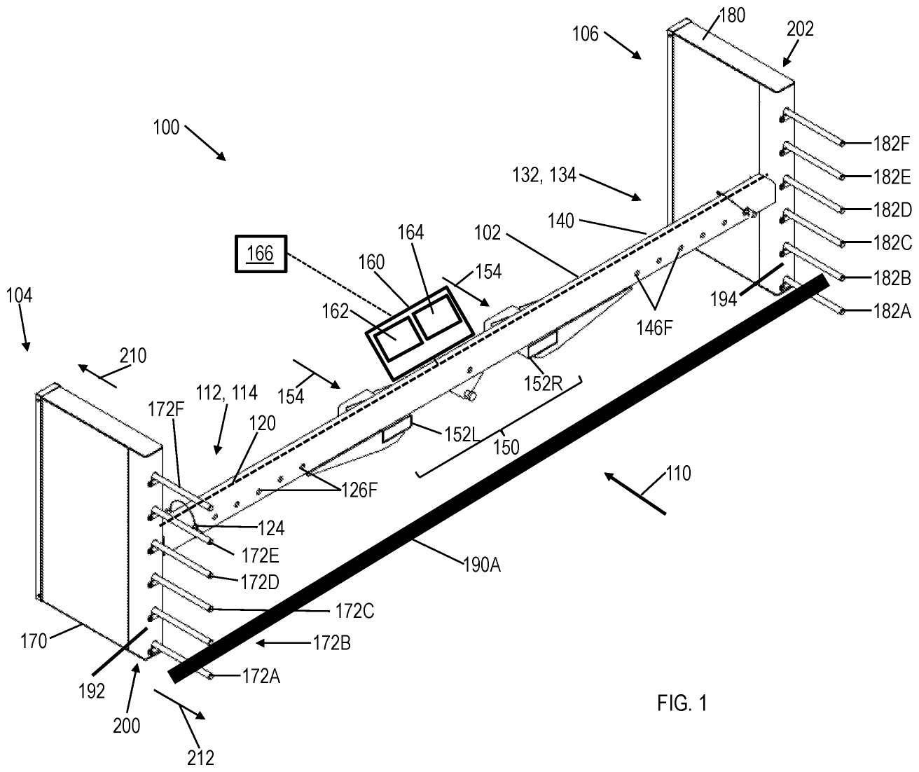

FIG. 1 is a perspective view of an example embodiment of a load carrying and distributing device 100 which includes a platform 102, a left assembly 104, and a right assembly 106. The designators left and right as used herein are as viewed along line 110, are non-limiting, assigned only for clarity of disclosure purposes.

A left connection 112 selectively positions the left assembly 104 along a left end 114 of the platform 102. In this example embodiment, the left connection 112 includes a left female portion 120 on the platform 102, a left male portion 122 (not visible in FIG. 1) of the left assembly 104, and a left pin 124 that is used to secure the left male portion 122 in a select position in the left female portion 120 via left positioning holes 126F, 126M (not visible in FIG. 1).

Similarly, a right connection 132 selectively positions the right assembly 106 along a right end 134 of the platform 102. In this example embodiment, the right connection 132 includes a right female portion 140 on the platform 102, a right male portion 142 (not visible in FIG. 1) of the right assembly 106, and a right pin 144 that is used to secure the right male portion 142 in a select position in the right female portion 140 via right positioning holes 146F, 146M (not visible).

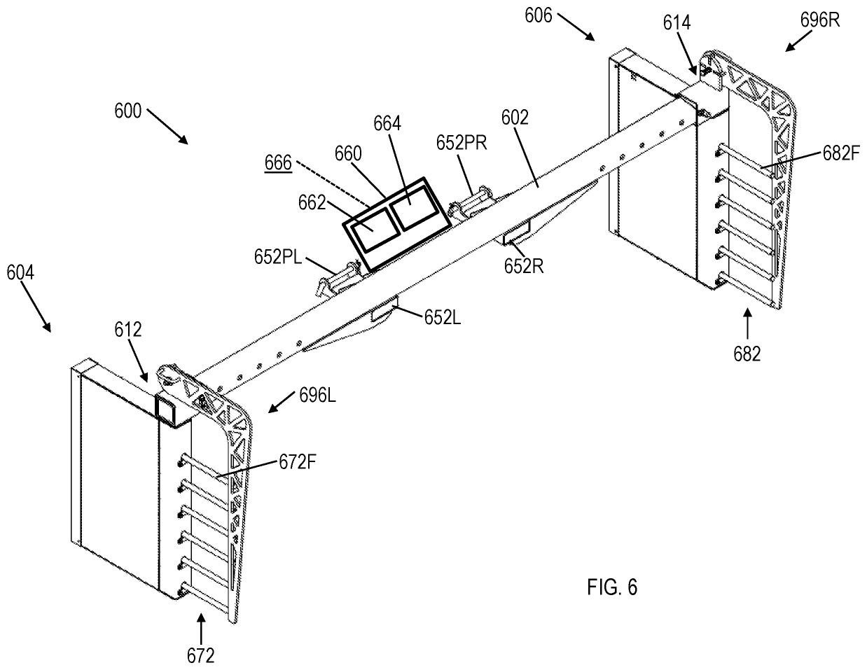

The platform 102 includes a fork receptacle arrangement 150 configured to receive conventional forks (not shown) present on load-carrying vehicles. The fork receptacle arrangement 150 may take any of a variety of known suitable configurations. In this example embodiment, there is a left fork receptacle 152L for one fork and a right fork receptacle 152R for another fork. The forks enter the left fork receptacle 152L and the right fork receptacle 152R by traveling in direction 154 as indicated by the arrows. In an example embodiment, respective bolts may be used to tighten against the forks and thereby hold the forks inside the left fork receptacle 152L and the right fork receptacle 152R. Alternately, or in addition, respective pins (not shown) may pass through each fork to secure the forks inside the left fork receptacle 152L and the right fork receptacle 152R. In an example embodiment. In an example embodiment, the forks do not extend past the left fork receptacle 152L and the right fork receptacle 152R to avoid interfering with the load stack. Alternately, the left fork receptacle 152L and the right fork receptacle 152R may operate as discussed in the embodiment of FIG. 6.

A controller 160 having a transmitter 162, and a receiver 164 is in data and electrical communication with the left assembly 104 and the right assembly 106 to control the left assembly 104 and the right assembly 106. A wired and/or wireless remote control 166 is in data communication with the controller 160 to permit wired and/or wireless remote control of the controller 160 and thereby of the left assembly 104 and the right assembly 106. Alternately, manual control of the left assembly 104 and right assembly 106 is possible.

The left assembly 104 includes a left support 170 and a plurality of selectively extendable and retractable shafts disposed in a stack like rungs in a ladder, including left shaft #1 172A, left shaft #2 1728, left shaft #3 172C, left shaft #4 172D, left shaft #5 172E, left shaft #6 172F. Similarly, right assembly 106 includes a right support 180 and a plurality of infinitely selectively extendable and retractable shafts disposed in a stack like rungs in a ladder, including right shaft #1 182A, right shaft #2 1828, right shaft #3 182C, right shaft #4 182D, right shaft #5 182E, right shaft #6 182F. The shafts 172A-E, 182A-E are shown in an extended position in which the shafts cantilever out from the respective support 170, 180. In any number of retracted positions, the shafts 172A-E, 182A-E extend from the supports 170, 180 to a lesser degree. In an example embodiment, in a fully retracted position, the shafts 172A-E, 182A-E are fully retracted into the respective supports 170, 180.

Shafts 172A 182A are configured to support a first horizontal load 190A that is horizontal and are configured to simultaneously extend and simultaneously retract (e.g., mutual extension and retraction). When retracting, a forward end of the left support 170 acts as a left stop 192 and a forward end of the right support 180 acts as a right stop 194. When the shafts 172A 182A retract under the first horizontal load 190A, the first horizontal load 190A may initially move with the retracting shafts 172A 182A. Once the first horizontal load 190A abuts the left stop 192 and the right stop 194, the left stop 192 and the right stop 194 hold the first horizontal load 190A in place and this permits the shafts 172A 182A to fully retract into the supports 170, 180 under the first horizontal load 190A. Once the shafts 172A 182A are fully retracted, the weight of the first horizontal load 190A is transferred to the delivery destination, for example, rafters.

Shafts 172B 182B are configured to support a respective horizontal load (not shown in FIG. 1) in a position over the first horizontal load 190A. In this configuration, the first horizontal load 190A and the second horizontal load form a stack. The same operation and function also apply to #3 shafts 172C and 182C, #4 shafts 172D and 182D, #5 shafts 172E and 182E, and #6 shafts 172F and 182F. Any number of shaft pairs (e.g., 172A, 182A) can be used.

In the example embodiment shown, the left end 114 of the platform 102 connects to a forward end 200 the left support 170. Similarly, the right end 134 of the platform 102 connects to a forward end 202 of the right support 180. In this example embodiment, the left support 170 and the right support 180 extend/project in a rearward direction 210 relative to the platform 102. The shafts 172A-F, 182A-F extend/project/cantilever in a forward direction 212 relative to the platform 102. This arrangement uses the weight of the left support 170 and the right support 180 to counterbalance the weight of the load(s) 190 forward and rearward about the platform 102.

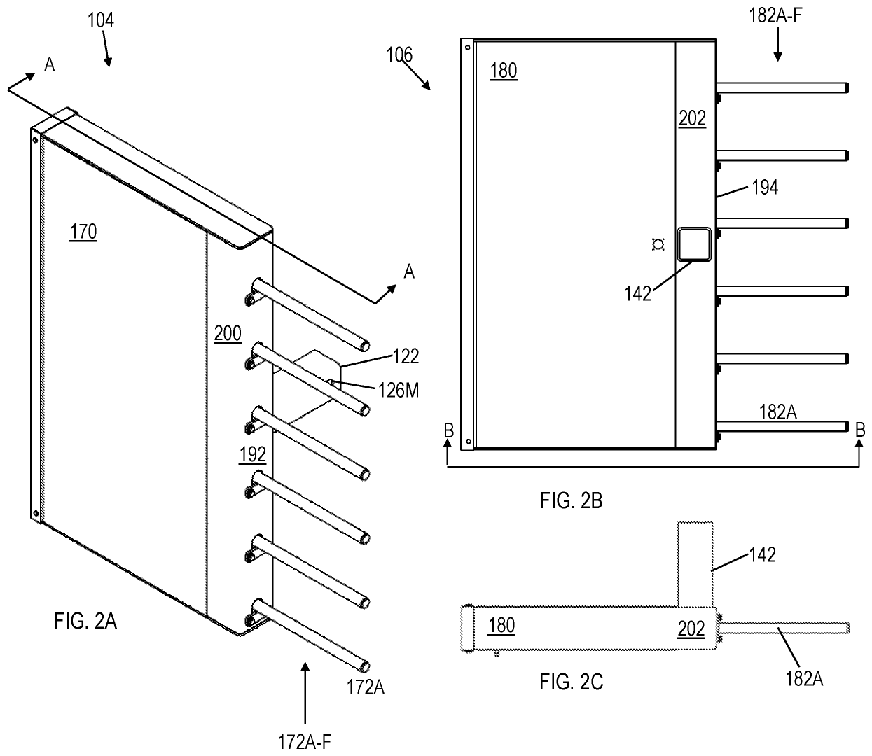

FIG. 2A is a perspective view of the left assembly 104. FIG. 2B is a side view of the right assembly 106. FIG. 2C is a bottom view of the right assembly 106 along line B-B of FIG. 2B.

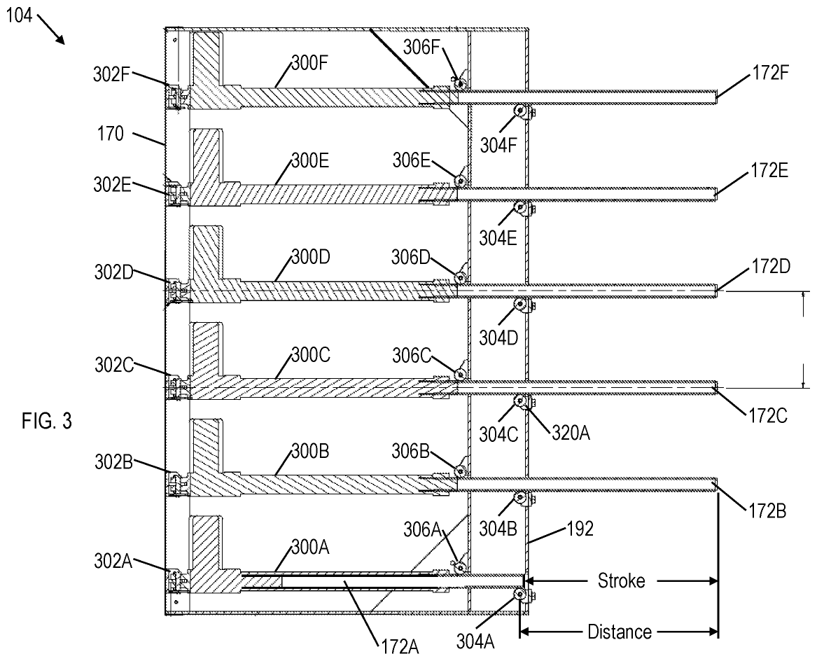

FIG. 3 is a cross section of the left assembly 104 along ling A-A in FIG. 2A. A left #1 actuator 300A is secured to the left support 170 via a left #1 actuator rear mount 302A, secured to the left #1 shaft 172A, and configured to move the left #1 shaft between the extended position and a retracted position (shown). The left #1 shaft 172A rests on left #1 forward rollers 304A that are secured to the forward end 200 of the left support 170 and is guided (laterally constrained from movement in and out of the page) by the left #1 forward rollers 304A and the left #1 upper rollers 306A.

Similarly, a left #2 actuator 300B is secured to the left support 170 via a left #2 actuator rear mount 302B, secured to the left #2 shaft 172B, and configured to move the left #2 shaft between the extended position (shown) and a retracted position. The left #2 shaft 172B rests on left #2 forward rollers 304B that are secured to the forward end 200 of the left support 170 and is guided (laterally constrained from movement in and out of the page) by the left #2 forward rollers 304B and the left #2 upper rollers 306B.

A left #3 actuator rear mount 302C, a left #4 actuator rear mount 302D, a left #5 actuator rear mount 302E, and a left #6 actuator rear mount 302F secure a left #3 actuator 300C, a left #4 actuator 300D, a left #5 actuator 300E, and a left #6 actuator 300F to the left support 170, respectively. Left #3 forward rollers 304C, left #4 forward rollers 304D, left #5 forward rollers 304E, and left #6 forward rollers 304F support the left #3 shaft 172C, the left #4 shaft 172D, the left #5 shaft 172E, and the left #6 shaft 172F, respectively. The left #3 forward rollers 304C, the left #4 forward rollers 304D, the left #5 forward rollers 304E, the left #6 forward rollers 304F, and left #3 upper rollers 306C, left #4 upper rollers 306D, left #5 upper rollers 306D, and left #6 upper rollers 306E laterally guide the left #3 shaft 172C, the left #4 shaft 172D, the left #5 shaft 172E, and the left #6 shaft 172F respectively.

For a left #1 actuator 300A having a Stroke of X, a Distance shown in FIG. 3A (between a bitter end of the left #1 shaft 172A and a center of the left #1 forward rollers 304A) should be less than or equal to X. This ensures that when the left #1 actuator 300A fully retracts the left #1 shaft 172A, the left #1 shaft 172A continues to be supported by the left #1 forward rollers 304A. In an example embodiment, the Stroke is sixteen (16) inches, and the Distance is approximately fifteen and three quarter (15¾) inches. This operation applies mutatis mutandis to all the left shafts 172.

A variety of linear actuators known to the artisan can be used, including hydraulic, pneumatic, screw, rack and pinion etc.

While individual actuators are shown for the left #1 shaft 172A and the right #1 shaft 182A, it is possible to have a single actuator that actuates both the left #1 shaft 172A and the right #1 shaft 182A. This applies to each shaft pair: 172A 182A; 172B 182B; 172C 182C; 172D 182D; 172E 182E; and 172F 182F.

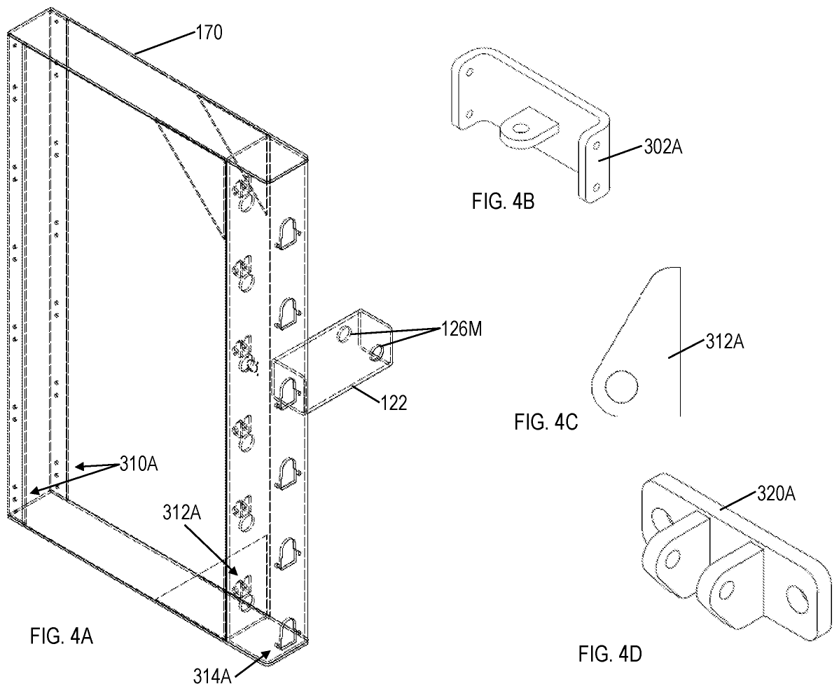

FIG. 4A is a perspective view of the left support 170. Left #1 actuator rear mount mounting holes 310A are used to mount the left #1 actuator rear mount 302A (shown in FIG. 4B) to the left support 170. Left #1 roller mount plates 312A (shown in FIGS. 4A and 4C) are secured to the left support 170 and support the left #1 upper rollers 306A. Left #1 forward roller bracket mounting holes 314A are used to mount a left #1 roller bracket 320A (shown in FIG. 4C) to the left support 170. The left #1 roller bracket 320A supports the left #1 forward rollers 304A. Although example embodiments are shown, any suitable mount for the rollers and for the actuators known to the artisan may be used.

The above description of the structure and function related to the left #1 actuator rear mount mounting holes 310A, left #1 roller mount plates 312A, left #1 forward roller bracket mounting holes 314A, and the left #1 roller bracket 320A applies mutatis mutandis for all the left actuators 300.

Likewise, the above description of the structure and function of the left assembly 104 applies mutatis mutandis to the right assembly 106.

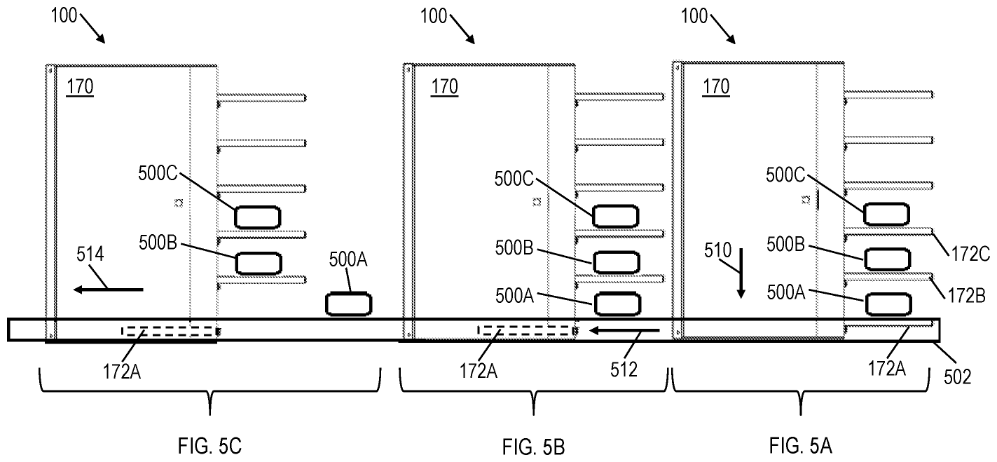

FIG. 5A to FIG. 5C show left side views of various steps associated with distributing of a load using the load carrying and distributing device 100. In FIG. 5A, a first horizontal load 500A is supported by the left #1 shaft 172A and the right #1 shaft 182A (not visible in FIG. 5A to FIG. 5C). A second horizontal load 500B is supported by the left #2 shaft 172B and the right #2 shaft 182B (not visible in FIG. 5A to FIG. 5C) and is disposed above first horizontal load 500A. A third horizontal load 500C is supported by the left #3 shaft 172C and the right #3 shaft 182C (not visible in FIG. 5A to FIG. 5C) and is disposed above second horizontal load 500B. Additional horizontal loads may be carried on respective increasingly elevated pairs of left and right shafts. The first horizontal load 500A, the second horizontal load 500B, and the third horizontal load 500c are discrete parts of a load stack that is being carried by the load carrying and distributing device 100.

As seen in FIG. 5A, the load carrying and distributing device 100 is moved into a first delivery location and lowered as shown by arrow 510 until an external support 502 (e.g., a rafter) takes the weight of the first horizontal load 500A (e.g., a first purlin). Once the external support 502 has the weight, the left #1 shaft 172A and the right #1 shaft 182A (not visible in FIG. 5A to FIG. 5C) are retracted as shown in the direction indicated by arrow 512 in FIG. 5B from the fully extended position shown in FIG. 5A to the fully retracted position shown in FIG. 5B. With the first horizontal load 500A thus delivered to the first delivery location, the load carrying and distributing device 100 is moved rearward as shown by arrow 514 in FIG. 5C to a second delivery location. The delivery process is then repeated mutatis mutandis for each horizontal load 500 at respective delivery locations.

For example, with the second horizontal load 500B at the second delivery location, the load carrying and distributing device 100 is further lowered until the weight of the second horizontal load 500B is taken by the external support 502, the left #2 shaft 1728 and the right #2 shaft 1828 (not visible in FIG. 5A to FIG. 5C) are fully retracted to the fully retracted position, and the second horizontal load 500B is thereby delivered. The load carrying and distributing device 100 is then moved rearward to a third delivery location to deliver the third horizontal load 500C in the same manner.

Alternative delivery techniques are possible, as are any combinations of the delivery techniques. For example, the external support 502 may take all, some, or none of the weight before the respective shafts are fully retracted. In an example embodiment, the left #1 shaft 172A and the right #1 shaft 182A are retracted while still bearing at least some of the weight of the first horizontal load 500A. In this case, once the first horizontal load abuts the left stop 192 and the right stop 194 stop, the left stop 192 and the right stop 194 stop would hold the first horizontal load 500A in position as the left #1 shaft 172A and the right #1 shaft 182A are retracted under the first horizontal load 500A until the first horizontal load 500A drops to the delivery location under the influence of gravity.

Although the horizontal loads have been shown as being straight, there are instances when they sag. In some cases, the ends of the horizontal loads contact each other while in the load stack. For example, a sagging second horizontal load 500B may sag enough that ends of the sagging second horizontal load 500B may contact the underlying first horizontal load 500A, which itself may also be sagging. In such a case, simply lowering the first horizontal load 500A onto the external support 502 and then backing the boom rearward does not work well. This is because as the first horizontal load 500A is lowered onto the external support 502, it tends to flatten out (when the external support is wider than the load carrying and distributing device 100). This causes the first horizontal load 500A to progressively straighten as the external support 502 takes the weight of the first horizontal load 500A. As the first horizontal load 500A straightens, its ends lift upward and come into contact with, (or increased contact with), the sagging ends of the sagging second horizontal load 500B above it. When the conventional boom is then moved rearward, the sagging second horizontal load 500B moves rearward with the boom and the sagging ends of the second horizontal load 500B that are in contact with the first horizontal load 500A tend to drag the first horizontal load 500A along with it.

The retractable shafts disclosed herein overcome this problem by making it possible to eliminate the contact between the first horizontal load 500A and the sagging second horizontal load 500B. Once the first horizontal load 500A is delivered, because the left #1 shaft 172A and the right #1 shaft 182A are retracted, the load carrying and distributing device 100 can be raised in place until the sagging second horizontal load 500B is no longer in contact with the first horizontal load 500A. Once the second horizontal load 500B is so raised and no longer in contact with the first horizontal load 500A, the load carrying and distributing device 100 can be moved rearward without dragging the first horizontal load 500A rearward with it. This technique is not possible with conventional delivery devices.

FIG. 6 is a perspective view of another example embodiment of a load carrying and distributing device 600. The load carrying and distributing device 600 includes a platform 602, a left assembly 604, a right assembly 606, a left connection 612, a right connection 614, a left fork receptacle 652L, and a right fork receptacle 652R. The left assembly 604 includes left retractable shafts 672 and the right assembly 606 includes right retractable shafts 682.

The load carrying and distributing device 600 optionally includes a controller 660 having a transmitter 662, a receiver 664 in data and electrical communication with the left assembly 604 and the right assembly 606 to control the left assembly 604 and the right assembly 606, and a wired and/or wireless remote control 666 in data communication with the controller 660 to permit wired and/or wireless remote control of the controller 660 and thereby of the left assembly 604 and the right assembly 606. Alternately, manual control of the left assembly 604 and the right assembly 606 is possible.

Various aspects present in the load carrying and distributing device 600 of FIG. 6 that differ from the load carrying and distributing device 100 of FIG. 1 to FIG. 5 are discussed below.

In this example embodiment, the left connection 612 and the right connection 614 are moved to a top of the left assembly 604 and the right assembly 606 respectively. This arrangement is advantageous in that it places all of the left retractable shafts 672 and the right retractable shafts 682 below the platform 602. This improves visibility for an operator who may be looking up at the load carrying and distributing device 600 while placing the loads 500A-500C.

In addition, the left fork receptacle 652L and the right fork receptacle 652R include respective pins 652PL and 652PR. In this example embodiment, the forks of the load carrying vehicle (e.g., the forklift) can be fully inserted into the left fork receptacle 652L and the right fork receptacle 652R. The pins 652PL and 652PR can then be installed behind the heal of the forks. Such an arrangement provides suitable stability and safety.

Further, when so located, the load carrying and distributing device 600 can place loads (e.g., loads 500A-500C etc.) on left and right external supports 502 without the platform 602 dropping below and between the left and right external supports 502. This is true for loads disposed all the way up to and on the uppermost left retractable shaft 672F and right retractable shaft 682F. This, in turn, enables the load carrying and distributing device 600 of FIG. 6 to place loads on a wider variety of arrangements of supports 502. An example arrangement of supports 502 includes three external a left external support, a right external support, and a middle external support disposed there between. Another example includes a left external support and a right external support with an obstruction there between. Yet another example includes a left external support and a right external support where one or both of the left and right external supports fit between the left assembly 604 and the right assembly 606. Hence, unlike the embodiment of FIG. 1 where there must be room between the left and right support for the entire load carrying and distributing device 100 to be lowered there between to place loads that are disposed on the upper shafts, in the embodiment of FIG. 6 there only needs to be room for the left assembly 604 and the right assembly 606 to drop below the supports for all loads.

The load carrying and distributing device 600 further includes a left guard assembly 696L and a right guard assembly 696R, both shown in a closed configuration to retain loads (e.g., loads 500A-500C etc.) on the left retractable shafts 672 and the right retractable shafts 682 as discussed in detail below.

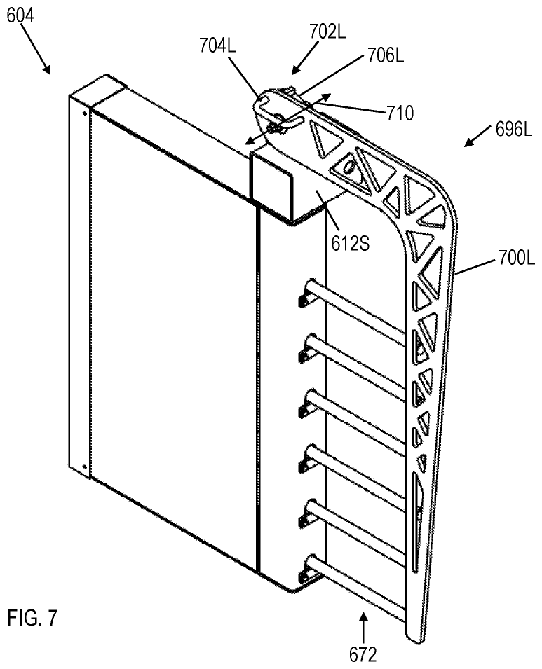

FIG. 7 is a perspective view of the example embodiment of the left assembly 604 of the load carrying and distributing device 600 of FIG. 6. The left guard assembly 696L and the right guard assembly 696R may be the same as each other and as shown in FIG. 7. They may be the same as each other and mirror images of that shown in FIG. 7.

The left guard assembly 696 and the right guard assembly 698 may be different from each other, with one guard assembly being that shown in FIG. 7 and the other being a mirror image thereof. As such, any explanation below of an assembly/component is applicable, mutatis mutandis, to a mirror image thereof.

The left guard assembly 696 includes a left guard 700L secured to a left pivot joint 702L, and a left handle 704L. The left guard 700L is configured to pivot at the left pivot joint 702L between the closed position (shown) and an open position in which the loads (e.g., loads 500A-500C etc.) are not retained on the left retractable shafts 672 and the right retractable shafts 682. The left pivot joint 702L includes a left pivot joint mount 706L secured in this embodiment to a sleeve 612S of the left connection 612.

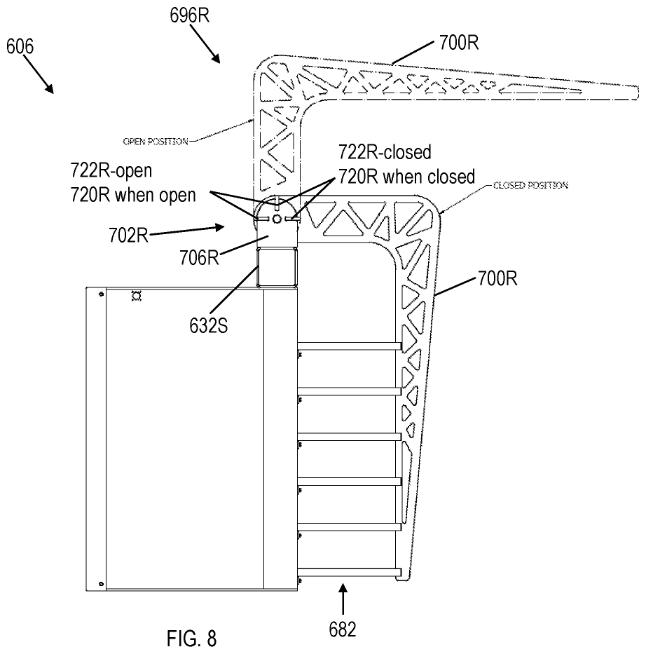

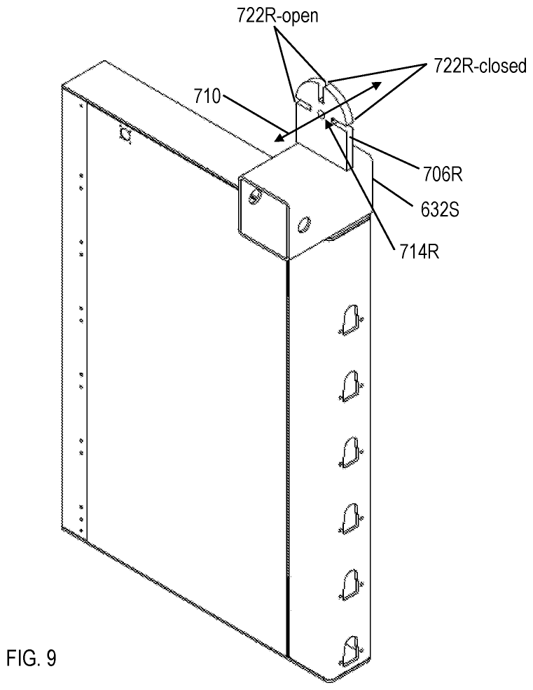

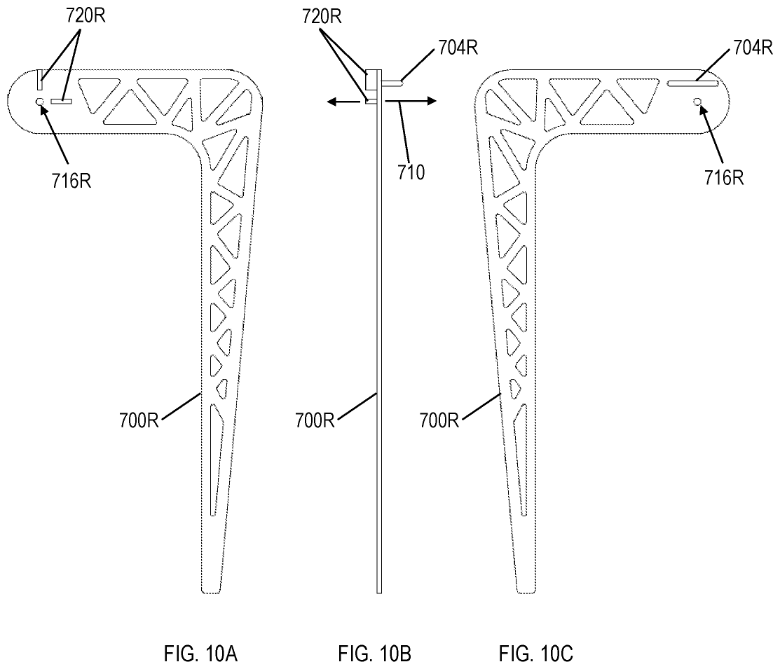

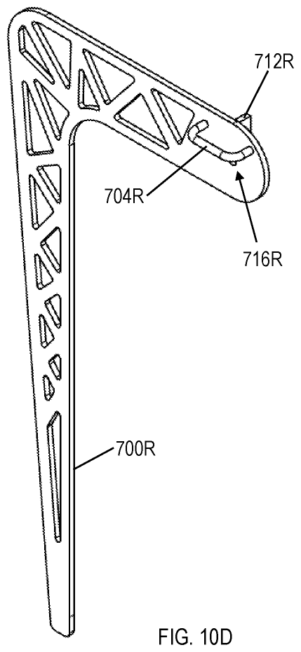

FIG. 8 to FIG. 10D show various views of the right assembly 606 and the right guard assembly 696R of the load carrying and distributing device 600 of FIG. 6. FIG. 8 is a side view of the right assembly 606. FIG. 9 is a perspective view of the right support of the right assembly of FIG. 8. FIG. 10A to FIG. 10D are inside side, front side, outside side, and perspective views of the guard 700R of the right guard assembly 696R of FIG. 8.

Similar to the left guard assembly 696L, the right guard assembly 696R shown includes a right guard 700R secured to a right pivot joint 702R, and a right handle 704R. The right guard 700R is configured to pivot at the right pivot joint 702R between the closed position and the open position as shown. The right pivot joint 702R includes a right pivot joint mount 706R secured in this embodiment to a sleeve 632S of the right connection 632.

A fastener, rod, or the like (not shown) is disposed in hole 714R in the right pivot joint mount 706R and in hole 716R in the right guard 700R. This allows the right guard 700R to move laterally along axis 710. Right tabs 720R selectively engage either slots 722R-closed or slots 722R-open. This engagement is effected by aligning the right tabs 720R with either slots 722R-closed or slots 722R-open and moving the right guard 700R along the axis 710 toward the right pivot joint mount 706R until the right tabs 720R engage the selected slots.

For example, if the right guard 700R is to be held in the closed position, with the right guard 700R held away from the right pivot joint mount 706R, the right tabs 720R are aligned with the slots 722R-closed and the right guard 700R is then moved toward the right pivot joint mount 706R until the right tabs 720R engage the slots 722R-closed. To move the right guard 700R from the closed position to the open position, the right guard 700R is moved along axis 710 until the right tabs 720R disengage from the slots 722R-closed. The right guard 700R is then rotated up (counterclockwise in FIG. 8) until the right tabs 720R align with the slots 722R-open. Once aligned, the right guard 700R is then moved toward the right pivot joint mount 706R until the right tabs 720R engage the slots 722R-open. This process is simply reversed to move the right guard 700R back to the closed position.

The right guard 700R may optionally be biased (e.g., via a spring (not shown)) toward the right pivot joint mount 706R such that an operator must overcome the bias to disengage the right tabs 720R from the slots 722R-closed, 722R-open. Alternately, or in addition, there may be any one or more of a slip fit, a friction fit, a geometric interlock, and an external locking mechanism to hold the right guard 700R in the selected position.

The load carrying and distributing device 100 disclosed provides advantages over the prior art and enable simple and efficient carrying and distribution of stacked loads. Consequently, the load carrying and distributing device 100 represents an improvement in the art.

While various embodiments of the present invention have been shown and described herein, it will be obvious that such embodiments are provided by way of example only. Numerous variations, swapping of features among embodiments, changes, and substitutions may be made without departing from the invention herein. Accordingly, it is intended that the invention be limited only by the spirit and scope of the appended claims.

The invention claimed is:

1. An apparatus, comprising:
a left assembly comprising a left support, a left #1 shaft configured to cantilever from the left support when in an extended position, and a left #2 shaft configured to cantilever from the left support and when in an extended position to be disposed above the left #1 shaft;
a right assembly comprising a right support, a right #1 shaft configured to cantilever from the right support when in an extended position, and a right #2 shaft configured to cantilever from the right support when in an extended position and to be disposed above the right #1 shaft;
wherein the left #1 shaft and the right #1 shaft are selectively extendable and retractable and configured to support a first horizontal load when in the extended position; and
wherein the left #2 shaft and the right #2 shaft are selectively extendable and retractable and configured to support a second horizontal load over the first horizontal load when in the extended position.

2. The apparatus of claim 1,
wherein the left assembly further comprises a left stop, wherein when in a retracted position the left #1 shaft and the left #2 shaft are fully retracted behind the left stop; and
wherein the right assembly further comprises a right stop, wherein when in a retracted position the right #1 shaft and the right #2 shaft are fully retracted behind the right stop.

3. The apparatus of claim 1, further comprising a platform configured to secure the left assembly and the right assembly in a fixed positional relationship with each other.

4. The apparatus of claim 3, further comprising: a left connection that selectively positions the left assembly along a left end of the platform; and a right connection that selectively positions the right assembly along a right end of the platform; wherein the left connection and the left connection are effective to enable selection of a distance between the left assembly and the right assembly.

5. The apparatus of claim 3, wherein the platform comprises a fork receptacle arrangement configured to receive forks of a load-carrying vehicle.

6. The apparatus of claim 1, further comprising: a left #1 actuator secured to the left support and to the left #1 shaft and configured to move the left #1 shaft between the extended position and a retracted position; a left #2 actuator secured to the left support and to the left #2 shaft and configured to move the left #2 shaft between the extended position and a retracted position; a right #1 actuator secured to the right support and to the right #1 shaft and configured to move the right #1 shaft between the extended position and a retracted position; and a right #2 actuator secured to the right support and to the right #2 shaft and configured to move the right #2 shaft between the extended position and a retracted position.

7. The apparatus of claim 6, wherein left #1 actuator and the left #2 actuator are disposed in the left support; wherein the right #1 actuator and the right #2 actuator are disposed in the right support; wherein a forward side of the left support acts as a left stop behind which the left #1 shaft and the left #2 shaft retract; and wherein a forward side of the right support acts as a right stop behind which the right #1 shaft and the right #2 shaft retract.

8. The apparatus of claim 6, wherein the left #1 shaft, the left #2 shaft, the right #1 shaft, and the right #2 shaft extend forward when in respective extended positions; and wherein the left #1 actuator, the left #2 actuator, the right #1 actuator, and the right #2 actuator extend rearward when in respective extended positions, which is effective to counterbalance a weight of the first horizontal load on the left #1 shaft and the right #1 shaft and the second horizontal load on the left #2 shaft and the right #2 shaft.

9. The apparatus of claim 6, further comprising: a controller in data communication with the left #1 actuator, the left #2 actuator, the right #1 actuator, and the right #2 actuator; wherein the controller is configured to enable: independent control of mutual extension and retraction of the left #1 shaft with the right #1 shaft; and independent control of mutual extension and retraction of the left #2 shaft with the right #2 shaft.

10. An apparatus, comprising:
a left assembly comprising a selectively extendable and retractable left #1 shaft and a selectively extendable and retractable right #1 shaft, the left #1 shaft and the right #1 shaft being configured to support a first horizontal load when in an extended position; and
a right assembly comprising a selectively extendable and retractable left #2 shaft disposed above the left #1 shaft and a selectively extendable and retractable right #2 shaft disposed above the right #1 shaft, the left #2 shaft and the right #2 shaft being configured to support a second horizontal load over the first horizontal load when in an extended position,
wherein the left assembly further comprises a selectively positionable left guard assembly configured to retain a load disposed on the left #1 shaft and the left #2 shaft when in a closed position and to not retain the load disposed on the left #1 shaft and the left #2 shaft when in an open position, and
wherein the right assembly further comprises a selectively positionable right guard assembly configured to retain a load disposed on the right #1 shaft and the right #2 shaft when in the closed position and to not retain the load disposed on the right #1 shaft and the right #2 shaft when in the open position.

11. The apparatus of claim 10, further comprising:
a platform secured between the left assembly and the right assembly;
a left connection that selectively positions the left assembly along a left end of the platform; and
a right connection that selectively positions the right assembly along a right end of the platform.

12. The apparatus of claim 10,
wherein the left assembly further comprises a left stop past which the left #1 shaft and the left #2 shaft are cantilevered when in respective extended positions, wherein in respective retracted positions the left #1 shaft and the left #2 are at least partly retracted into the left stop; and
wherein the right assembly further comprises a right stop which the right #1 shaft and the right #2 shaft are cantilevered when in respective extended positions, wherein in respective retracted positions the right #1 shaft and the right #2 are at least partly retracted into the right stop.

13. The apparatus of claim 12,
wherein the left assembly further comprises a left support from which the left #1 shaft and the left #2 shaft cantilever when in respective extended positions;
wherein the right assembly further comprises a right support from which the right #1 shaft and the right #2 shaft cantilever when in respective extended positions; and
wherein a forward side of the left support acts as the left stop behind which the left #1 shaft and the left #2 shaft retract; and wherein a forward side of the right support acts as the right stop behind which the right #1 shaft and the right #2 shaft retract.

14. The apparatus of claim 13, wherein the left support comprises a left #1 actuator configured to control to the left #1 shaft and a left #2 actuator configured to control the left #2 shaft; wherein the right support comprises a right #1 actuator configured to control to the right #1 shaft and a right #2 actuator configured to control the right #2 shaft.

15. The apparatus of claim 14, further comprising:
a platform secured between the left assembly and the right assembly;
wherein the left support extends rearward relative to the platform and the left #1 shaft and the left #2 shaft extend forward relative to the platform when in respective extended positions; and
wherein the right support extends rearward relative to the platform and the right #1 shaft and the right #2 shaft extend forward relative to the platform when in respective extended positions.

16. The apparatus of claim 10, wherein the left guard assembly comprises a left guard secured to the left assembly via a left pivot joint and configured to pivot at the left pivot joint between the closed position and the open position; and wherein the right assembly comprises a right guard secured to the right assembly via a right pivot joint and configured to pivot at the right pivot joint between the closed position and the open position.

17. An apparatus, comprising:
platform configured to be secured to forks or a load-carrying vehicle;
a left assembly, comprising: a left support secured to a left end of the platform; a left #1 shaft; a left #1 actuator configured to cantilever the left #1 shaft forward from the left support to an extended position and to retract the left #1 shaft at least partly into the left support to a retracted position; a left #2 shaft disposed above the left #1 shaft; and a left #2 actuator configured to cantilever the left #2 shaft forward from the left support to an extended position and to retract the left #2 shaft at least partly into the left support to a retracted position; and
a right assembly, comprising: a right support secured to a right end of the platform; a right #1 shaft; a right #1 actuator configured to cantilever the right #1 shaft forward from the right support to an extended position and to retract the right #1 shaft at least partly into the right support to a retracted position; a right #2 shaft disposed above the right #1 shaft; and a right #2 actuator configured to cantilever the right #2 shaft forward from the right support to an extended position and to retract the right #2 shaft at least partly into the right support to a retracted position,
wherein the platform is secured to an upper end of the left assembly and an upper end of the right assembly.

18. The apparatus of claim 17, further comprising a left connection that selectively positions the left assembly along the left end of the platform; and a right connection that selectively positions the right assembly along the right end of the platform; wherein the left connection and the left connection are effective to enable selection of a distance between the left assembly and the right assembly.

19. The apparatus of claim 17, wherein the left support extends rearward relative to the platform and the left #1 shaft and the left #2 shaft extend forward relative to the platform from the left support; and wherein the right support extends rearward relative to the platform and the right #1 shaft and the right #2 shaft extend forward relative to the platform from the right support.

20. The apparatus of claim 17, further comprising: a controller in data communication with the left #1 actuator, the left #2 actuator, the right #1 actuator, and the right #2 actuator; wherein the controller is configured to enable: independent control of mutual extension and retraction of the left #1 shaft with the right #1 shaft; and independent control of mutual extension and retraction of the left #2 shaft with the right #2 shaft.
